(19) United States
(12) Patent Application Publication
(10) Pub. No.: US 2012/0271932 A1
(43) Pub. Date: Oct. 25, 2012

(54) Method of Providing Process Operation in Software and Application Control Management Object

(76) Inventors: Chun-Ta Yu, Taoyuan County (TW); Yin-Yeh Tseng, Taoyuan County (TW)

(21) Appl. No.: 13/454,048

(22) Filed: Apr. 23, 2012

Related U.S. Application Data
(60) Provisional application No. 61/477,615, filed on Apr. 21, 2011.

(51) Int. Cl. G06F 15/173

(52) U.S. Cl. 709/223

(57) ABSTRACT

A method of providing process operation in a management object (MO) specification conformed to device management (DM) of Open Mobile Alliance (OMA) for a client is disclosed. The method comprises creating a first node and a second node in a process sub-tree of a management object, wherein the first node indicates an operation for the second node, and the second node indicates a destination on which the operation is executed.

### CROSS REFERENCE TO RELATED APPLICATIONS

This application claims the benefit of U.S. Provisional Application No. 61/477,615, filed on Apr. 21, 2011 and entitled “Method of Process Operation in SACMO”, the contents of which are incorporated herein in their entirety.

### BACKGROUND OF THE INVENTION

1. Field of the Invention

The present invention relates to a method used in a service system, and more particularly, to a method of providing process operation in software and application control management object for a service system.

2. Description of the Prior Art

Open Mobile Alliance (OMA) is founded to develop OMA specifications for mobile services to meet users' needs. Furthermore, the OMA specifications aim to provide the mobile services which are interoperable across geographic areas (e.g. countries), operators, service providers, networks, operation systems and mobile devices. In detail, the mobile services conforming to the OMA specifications can be used by the users without restriction to particular operators and service providers. The mobile services conforming to the OMA specifications are also bearer agnostic, i.e., the bearer that carries the mobile services can be a second generation (2G) mobile system such as GSM, EDGE or GPRS, or a third generation (3G) and beyond mobile system such as UMTS, LTE or LTE-Advanced. Further, the mobile services can be executed on an operation system such as Windows, Android or Linux operated on various mobile devices. Therefore, industries providing devices or the mobile services supporting the OMA specifications can benefit from a largely growing market enabled by interoperability of the mobile services. Besides, the users use the devices or the mobile services supporting the OMA specifications can also have a better experience due to the interoperability of the mobile services.

A device management (DM) protocol conforming to the OMA specifications is designed for management of devices such as mobile phones, PDAs and palm top computers. The device management is intended to support the following typical uses: configuration of device for allowing changes to settings and parameters of the device, software upgrades for providing new software (e.g. applications and system software) and/or bug fixes to be loaded on the device, and fault management for reporting errors from the device, and/or querying about status of the device. In addition, the DM protocol defines a way according to which a DM client (e.g. mobile device) communicates with a DM server (e.g. network), and thereby the DM client can feedback a command, a status or a report to the DM server. Further, the DM server manages the DM client through a set of management objects in the DM client. The management object is conformed to a Software and Application Control Management Object (SACMO) specification, which aims to enable remote operations for software and application control in the device. SACMO specifications will provide capabilities of processing management actions such as workflow, processing or on device management of software and applications utilizing existing management objects.

The goal of SACMO is to enable DM operations to be applied according to workflow scripts in the device, whereby any combination of operations on existing management objects can be applied and conditionally executed, with just the combined result being reported back to the DM server. This avoids a series of individual client-server interactions, thereby optimizing the network traffic and reducing the workflow execution time.

Please refer to FIG. 1, which is a schematic diagram of a SACMO management object tree in the prior art. The SACMO management object tree is used for setting up parameters and operational functionality necessary for managing a workflow object. A workflow is a sequence of steps which is conditionally executed. Each step can be an operation, process, command or other type of resource. Between steps, a condition is used to determinate the next step. A process is a basic unit for a specific operation execution. A process consists of an URI (Uniform Resource Identifier) path which indicates the node of target management object to execute. The process is indicated by a unique process ID and it can be reused in workflows. A step is a basic unit of a workflow which consists of a process and information for the next step(s). A step MUST have a process ID to indicate a corresponding process to be executed. If a step is followed by another step, a next step sub-tree is created. The next step sub-tree may contain multiple next Steps. Each next Step has a NextStepID to indicate the following Step and a condition to the next Step to be applied (optional).

In current design in SACMO, the process is designed to run an execution operation, Exec, on a node of a management object, or a node for an application, i.e. Process/<X>/TargetApp/ExecAppURI, wherein TargetApp is an interior node, which groups information used for executing an application, and ExecAppURI is an leaf node, which specifies a URI for an application to be executed. However, the SACMO specification does not define how to get a value from a node of the management object, and thereby the operation on a node of the management object is only allowed to do an Exec operation but cannot be used to get a value from a node. Note that the value got from the node may be compared with a predefined value in a “Condition” shown in FIG. 1. Besides, the SACMO specification does not define how to add or delete a node in a management object which is the fundamental operation of DM protocol.

### SUMMARY OF THE INVENTION

The disclosure therefore provides a method of providing process operation in software and application control management object (SACMO), so as to solve the abovementioned problems.

A method of providing process operation in a management object (MO) specification conformed to device management (DM) of Open Mobile Alliance (OMA) for a client is disclosed. The method comprises creating a first node and a second node in a process sub-tree of a management object, wherein the first node indicates an operation for the second node, and the second node indicates a destination on which the operation is executed.

A method of providing process operation in a management object (MO) specification conformed to device management (DM) of Open Mobile Alliance (OMA) for a client is disclosed. The method comprises creating a node in a process sub-tree of a management object, wherein the node indicates an operation and a destination on which the operation is executed, whereby the client performs the operation of the node on the destination of the node.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a SACMO management object tree in the prior art.

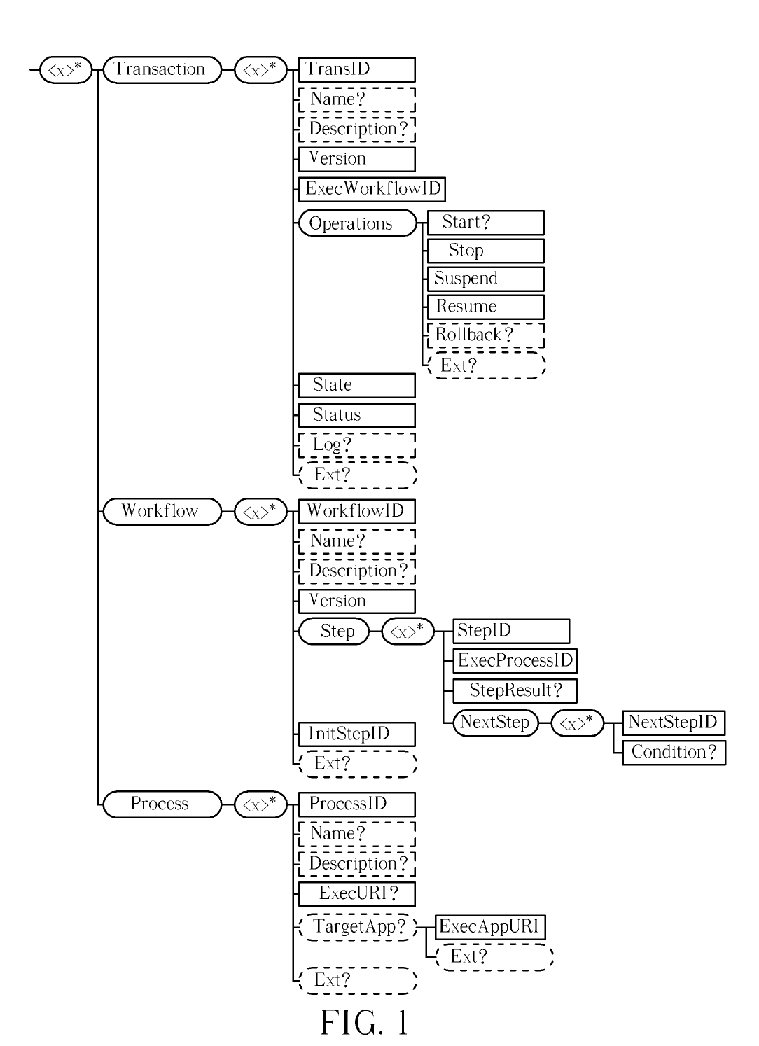

FIG. 2 is a schematic diagram of an exemplary service system.

FIG. 3 is a schematic diagram of an exemplary communication device.

FIG. 4 is a flowchart of an exemplary process.

FIG. 5 is a schematic diagram of a SACMO management object tree of the present invention.

FIG. 6 is a flowchart of an exemplary process.

### DETAILED DESCRIPTION

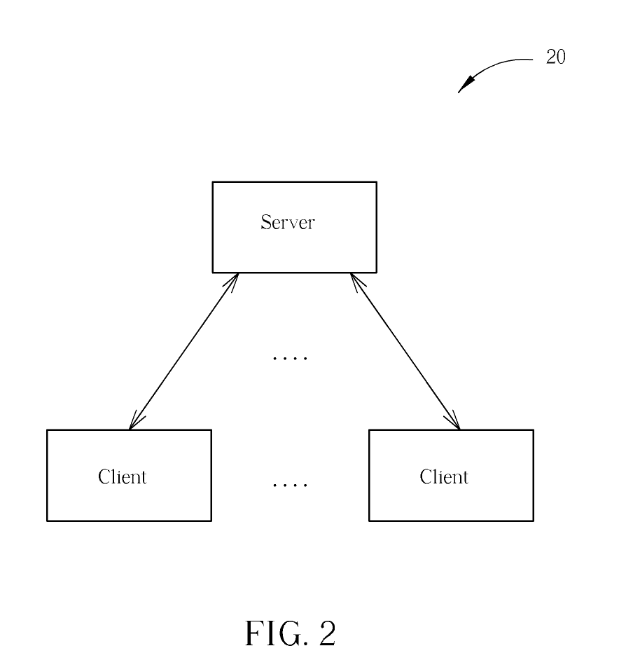

Please refer to FIG. 2, which is a schematic diagram of a service system 20 according to an example of the present disclosure. The service system 20 complies with an Open Mobile Alliance (OMA) Device Management (DM) protocol and is briefly composed of a server, and a client. The server and the client conform to a Management Object (MO) specification, e.g. Software and Application Control Management Object (SACMO). SACMO was proposed to enable DM operation to be applied according to workflow scripts in a device, whereby any combination of operations on existing management objects can be applied and conditionally executed, with just the combination result being reported back to the server. Note that, components of the SACMO includes process, step, workflow, and transaction, which shall be well known to those skilled in the art, so the detailed descriptions are not given herein.

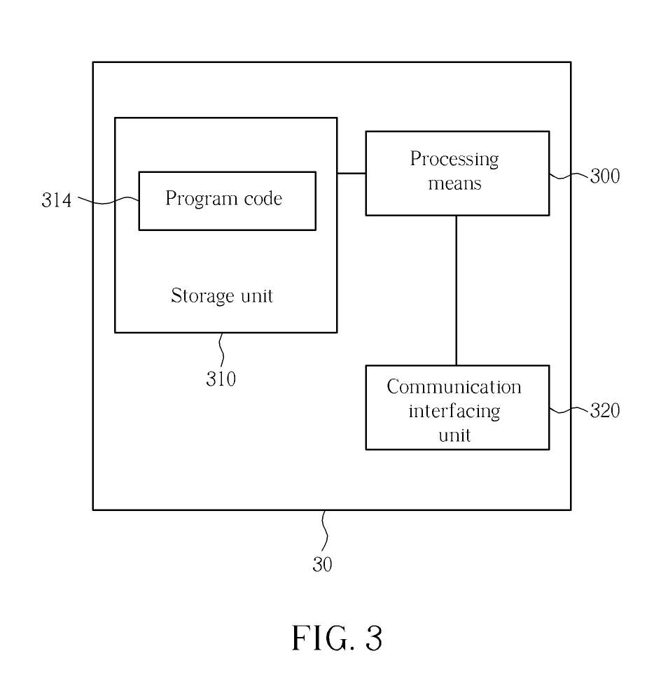

Please refer to FIG. 3, which is a schematic diagram of a communication device 30 according to an example of the present disclosure. The communication device 30 can be the server or the client shown in FIG. 2, but is not limited herein. The communication device 30 may include a processor 300 such as a microprocessor or Application Specific Integrated Circuit (ASIC), a storage unit 310 and a communication interfacing unit 320. The storage unit 310 may be any data storage device that can store a program code 314, accessed by the processor 300. Examples of the storage unit 310 include but are not limited to a subscriber identity module (SIM), read-only memory (ROM), flash memory, random-access memory (RAM), CD-ROM/DVD-ROM, magnetic tape, hard disk, and optical data storage device. The communication interfacing unit 320 is preferably a transceiver and can exchange signals with the server according to processing results of the processor 300.

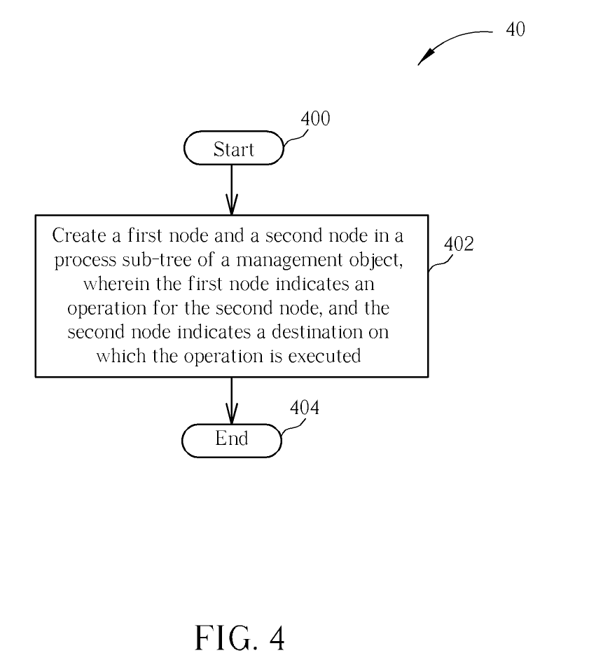

Please refer to FIG. 4, which is a flowchart of a process 40 according to an example of the present disclosure. The process 40 is used for providing process operation in a MO specification, e.g. SACMO, for the client shown in FIG. 2. The process 40 maybe compiled into the program code 314 and includes the following steps:

Step 400: Start.

Step 402: Create a first node and a second node in a process sub-tree of a management object, wherein the first node indicates an operation for the second node, and the second node indicates a destination on which the operation is executed.

Step 404: End.

According to the process 40, two nodes are created in the process sub-tree of a management object. The first node specifies an operation for a second node, and the second node points to a destination which the first node operates on. Therefore, the client performs the operation of the first node on the destination of the second node while the process is triggered. Based on the present development on OMA specifications, the management object in the process 40 is preferably a management object conformed to SACMO. The management object in the process 40 can be conformed to other type of the MO specification proposed to enable DM operation to be applied, not limited to be SACMO. It depends on if any other MO specification is proposed by OMA in the future and if the process 40 can be performed based on the new MO specification.

Note that, the operation of the first node is a DM command which may be “Get”, “Add”, “Replace”, “Delete”, “Execute” or other commands defined in the DM protocol. Or, the operation of the first node is a predefined command. For example, the predefined command may be “Get”, “Execute”, “Write”, etc. Moreover, the destination of the second code is a uniform resource identifier (URI), whereby the URI points to a node of a Management Object (MO) of the client or a location of an application. Thus, function of the process is extended, to allow it to run more DM commands on the node of the MO or run more predefined commands on the application.

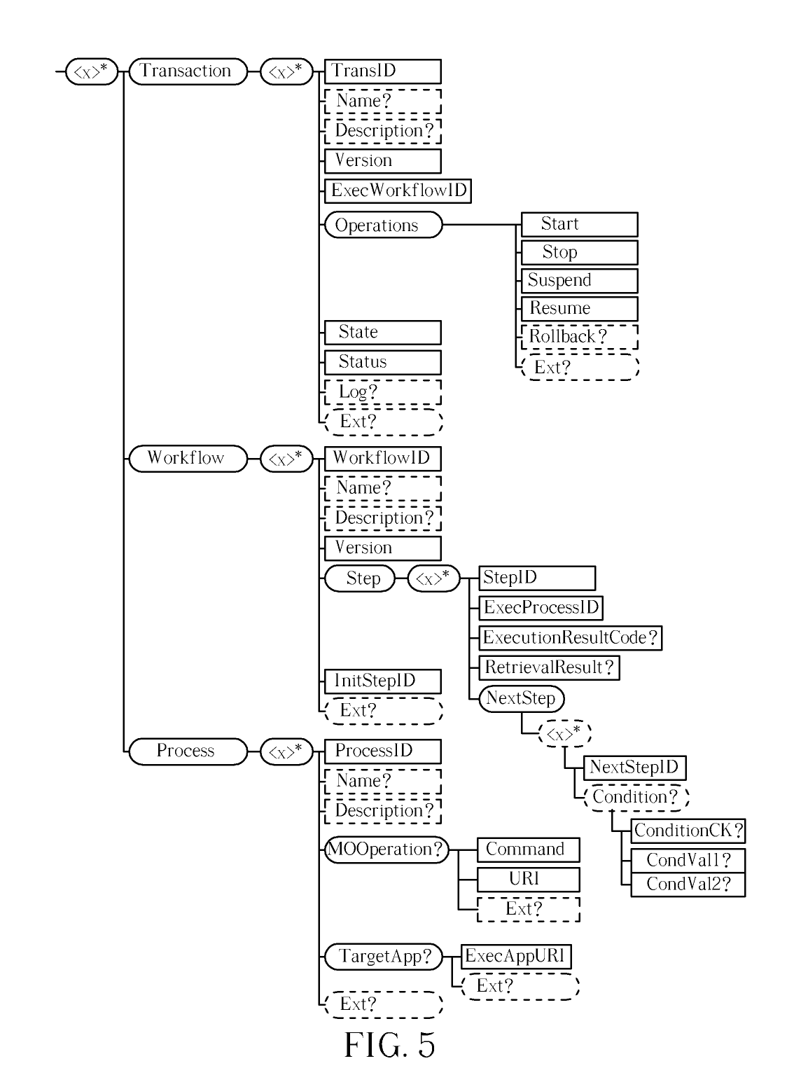

In detail, please refer to FIG. 5, which is a SACMO management object tree of the present invention. As can be seen, leaf nodes “Command” (i.e. Process/<X>/MOOperation/Command) and “URI” (i.e. Process/<X>/MOOperation/URI) under an interior node “MOOperation” (i.e. Process/<X>/MOOperation) are added in the process sub-tree of a management object conformed to the SACMO. The “Command” is a DM command (e.g. Get, Add, Replace, Delete, or Execute command) or a predefined command. The “URI” specifies an address, such as a node of a MO of the client, or a location of an application. With such manner, a value can be obtained from a node of the SACMO for comparison with a value in the “Condition”. For example, the “Command” node is a Get command, and “URI” node points to anode of the MO of the client, wherein the node stores a value. The client performs Get operation to get the value of the node. On the other hand, if the “Command” node is an Execute command and “URI” node points to a location of an application. The client performs Execute operation to execute the application.

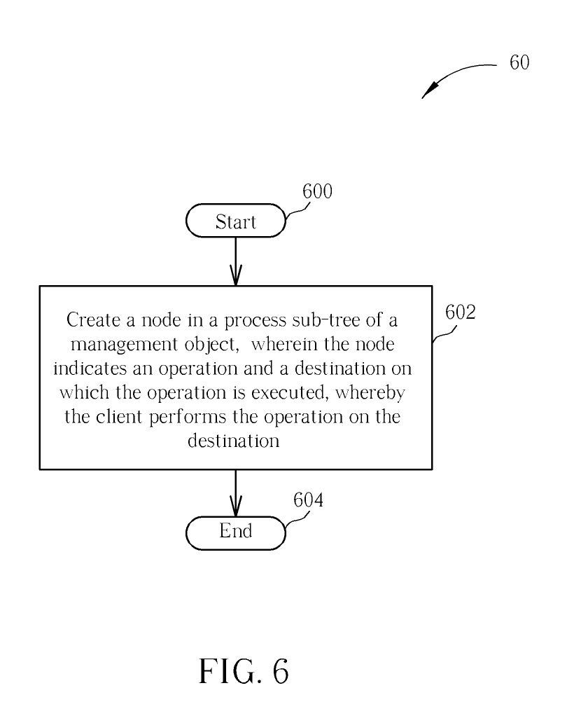

Please refer to FIG. 6, which is a flowchart of a process 60 according to an example of the present disclosure. The process 60 is used for providing process operation in a MO specification for the client shown in FIG. 2. The process 60 may be compiled into the program code 314 and includes the following steps:

Step 600: Start.

Step 602: Create a node in a process sub-tree of a management object, wherein the node indicates an operation and a destination on which the operation is executed, whereby the client performs the operation on the destination.

Step 604: End.

According to the process 60, an operation and a destination are put in one node of a process sub-tree of a management object. Therefore, the client performs the operation on the destination while the process is triggered. Based on the present development on OMA specifications, the management object in the process 60 is preferably a management object conformed to SACMO. The management object in the process 60 can be conformed to other type of the MO specification proposed to enable DM operation to be applied, not limited to be SACMO. It depends on if any other MO specification is proposed by OMA in the future and if the process 60 can be performed based on the new MO specification.

Note that, the operation of the node is a DM command which may be “Get”, “Add”, “Replace”, “Delete”, “Execute” or other commands defined in the DM protocol. Or, the operation of the node is a predefined command. For example, the predefined command may be “Get”, “Execute”, “Write”, etc. Moreover, the destination of the code is a uniform resource identifier (URI), whereby the URI points to a node of a MO or a location of an application. Thus, function of the process in the SAMCO is extended, to allow it to run more DM commands on the node of the MO or predefined commands on the application.

Unlike the process 40, only one node is added in the process sub-tree of the management object, which specifies a command and a destination which is a node in a MO of the client or a location of an application. The detailed description for the command can be referred from above, so it is omitted herein.

Please note that, the abovementioned steps of the processes including suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), and the communication device 30.

To sum up, the function of the process of the SACMO is enhanced by creating node(s) in the process sub-tree of a management object, so as to perform more operations (e.g. getting a value from a node of a MO).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of providing process operation in a management object (MO) specification conformed to device management (DM) of Open Mobile Alliance (OMA) for a client, the method comprising:
creating a first node and a second node in a process sub-tree of a management object;
wherein the first node indicates an operation for the second node, and the second node indicates a destination on which the operation is executed.

2. The method of claim 1, wherein the operation of the first node is indicated by a DM command defined in the DM protocol.

3. The method of claim 1, wherein the operation of the first node is indicated by a predefined command.

4. The method of claim 1, wherein the destination of the second code is in a uniform resource identifier (URI) format, whereby the URI points to a node of the management object—or a location of an application.

5. A method of providing process operation in a management object (MO) specification conformed to device management (DM) of Open Mobile Alliance (OMA) for a client, the method comprising:
creating a node in a process sub-tree of a management object, wherein the node includes an operation and a destination on which the operation is executed;
whereby the client performs the operation on the destination.

6. The method of claim 5, wherein the operation of the node is indicated by a DM command defined in a DM protocol.

7. The method of claim 5, wherein the operation of the node is indicated by a predefined command.

8. The method of claim 5, wherein the destination of the code is in a uniform resource identifier (URI) format, whereby the URI points to a node of the management object or a location of an application.
